(19) United States
(12) Patent Application Publication
(10) Pub. No.: US 2008/0294688 A1
(43) Pub. Date: Nov. 27, 2008

(54) DOORS - digital orientation and organizational reference system

(76) Inventor: Dorron L. Brousard, Englewood, NJ (US)

Correspondence Address: Dorron Brousard, 5 Fox Run Dr., Englewood, NJ, 07631, US

(21) Appl. No.: 11/562,098

(22) Filed: Nov. 21, 2006

(51) Int. Cl. G06F 7/00

(52) U.S. Cl. 707/104.1

(57) ABSTRACT

A method of presenting and testing for comprehension, organizational information commonly provided during new employee (or stakeholder) orientation and later made available in company or employee manuals. This method utilizes existing digital learning system technologies to author content, test and track results. This method is a Digital Orientation and Organizational Reference System (DOORS) that provides content at two levels. One level is used for orientation and testing with access to the second, reference level, mostly used by existing employees or stakeholders for review or clarification. The content, tests and results are securely available online, or on transferable media such as DVD or CDROM's. The uniqueness of this system lies in its standardized repeatability enabling organizations to lower orientation costs, and verify transfer and understanding of content to stakeholders should this become questionable in the workplace environment or under legal review.

### BACKGROUND OF THE INVENTION

The present invention relates to a method by which employers provide standardized and repeatable rules, regulations, procedures, employee conduct codes, security regulation issues, applicable employment laws and company policies to new and existing employees (internal), and outside representatives of the company. The acronym of DOORS stands for the method of Digital Orientation and Organizational Reference System.

Every company has a set of guidelines by which employees are expected to abide. In most cases the guidelines are written down and can be found in the company's employee manuals, also sometimes called policy manuals. In other cases these guidelines are verbal. In all cases company representatives who receive or don't receive remuneration, are expected to abide by these guidelines or policies.

While it is obvious that salaried employees must follow company guidelines, it may not be as obvious that outside representatives such as manufacturers representatives, commissioned sales representatives, distributors, and agents for the company in any manner shape or form including outside vendors such as PR and advertising firms, should also be obligated to follow some or all company guidelines.

When an action or claim is made that is contrary to company guidelines, objectives or laws (local, State, Federal, etc), events look to place the blame on the representative that committed the infraction or alternatively, on the company. A dispute then ensues as to who is at fault. The company's deep pockets are the first target for any liability claims. Most company's look at the representative who generated the infraction as the guilty party who should accept total liability.

The foregoing becomes obvious when an action taken or a claim made on behalf of the company results negatively on the company. At that time the question arises as to who is at fault; the company or its representative, who acted as an individual against company guidelines. The answer to this vital question determines to a great extent where liability lies. Since most representatives immediately claim innocence and state that no company guidelines covered the situation, the onus falls on the company to prove otherwise.

Unwritten, poorly written or lack of expressed guidelines (no guidelines) that cover the negative actions of its representatives opens the company to liability actions. Improper training or lack of enforcement of company guidelines is just as damaging and also opens the company to liability claims.

A company's representative is any individual or organization that speaks (communicates in any form) or acts in the name of a company. While I refer to “company” for convenience, this also includes any organization established for a common purpose. This may include but is not limited to, for profit companies, volunteer organizations, various levels of government, religious organizations, non-profit organizations, etc. Company representatives include employees, sales agents or sales organizations, distributors, vendors for the company or suppliers to the company. Vendors for the company may include advertising agencies, public relations firms, consultants, etc.

Companies are then examined under a magnifying glass to determine if they had done all that could be done to prevent the infraction. The onus falls on the company's to show that everything that could have been done was. Failing to prove their case, opens them up to liability claims. Proving their case, lowers their exposure to liability. New situations and unclear laws make it nearly impossible to cover all situations that may result in liability claims. This is obvious when considering that a motorist while driving and drinking a cup of hot coffee, accidentally spilled the coffee and was injured, and was later able to succeed in a liability claim against the supplier of the hot coffee.

Most companies with a printed company manual rely on a signed statement by their representatives that they have read and agree to abide by the contents of the manual. Many companies provide “training” at the very beginning of employment during which the company manual is distributed. These attempts to lower exposure to liability don't often succeed when tested in a court of law. Companies fail at proving that the representatives really read and/or understood the contents of the manual. When training is involved, companies fail to proves that all subjects were covered each and every time. Since trainers are human beings, there are deviations in what is covered and what is not. Even trainer's testing techniques have been proven to be faulty since many trainers emphasis which questions will be on the test. There also exists a conflict of interest. Since trainers want to show that the company's information has been conveyed and retained, they take small liberties to make sure enough representatives get high marks on any test they administer. This is an open door to litigation on any serious contest of the facts.

It becomes obvious that with today's technology a standardized and repeatable orientation tailored to each company's requirements can be an effective method of lowering corporate liabilities.

Other by-products surface when looking at the issues of empowering would be employees (and representatives) with appropriate workplace information. It has been shown that employees that receive better orientation, tend to be happier, more productive and sooner and in the long run, and stay with the company longer.

One issue that becomes obvious in any training environment is that people only tend to remember a small percentage of what was taught. That percentage deceases dramatically each week after the initial training. Some professionals indicate that only 20% is retained within 3 days after the training. After three weeks, less than 5% is retained, creating a need for a Human Resource department to provide reinforcement materials. While some administrative functions of the HR department are needed on an ongoing basis, reference materials should not be one of them. Most if not all of the reference material is the same material presented to the company's would be representative at “orientation”.

The DOORS system has a secondary objective of providing reference materials for existing employees (and representatives).

Savings in Liability issues, cost of turnover, increased efficiency, security matters, etc.

Another feature is training before employment to save organization money.

### NEED FOR THE INVENTION

The need for this invention comes from several areas that concern most companies. The first and most important area is liability. Liability claims are on the rise. Within this area of concern there are internal and external liability minefields that must be addressed. Employee harassment of another employee is an example of an internal liability issue. Sending or allowing a dangerous situation to occur with company clients or the public is an example of external liability issues that must be addressed.

The second area of need is cost for new hires. This is greater than in the past as a result of high employee turnover.

A third area of need is for increased worker performance and efficiency earlier on from their start date. While many employee positions allow for a lengthy “orientation” time for new employees, more companies are demanding immediate performance by new hires.

The fourth area of concern to companies lies in the need to adapt company and workplace policies to a dynamically changing environment. New laws, technologies and privacy concerns are a major driving force in this.

### SUMMARY OF THE INVENTION

Accordingly, it is the object of the present invention to provide a method and a system for companies to provide their new and existing representatives with an orientation and reference system that is consistent, repeatable, and verifiable. It will have the following features:

It lowers corporate exposure to liability claims

It takes advantage of today's existing technologies

It combines information at different levels of importance

It lowers corporate liabilities

It lowers HR costs

It lowers employee turnover

It Increase employee efficiencies

It is easily updated and consistently verifiable

It test employees resolve for employment

It lowers new employee orientation costs

It provides employees a defined environment within which to work

It provides management controls on important information

It defines security and proprietary issues

Although the invention has a common database of information, that information is provided in a secure defined environment, at two levels. The priority level is instructional with testing and mostly used by new employees. The reference level is used by both new and existing employees.

New or prospective employees, using timed and coded company supplied access codes can view the information and take tests, over the web, corporate network, or CDROM, as determined by company's management. At the company's discretion new or prospective employees can go through the orientation during non-working hours, saving the company time, money and the allocation of space.

Two elements make up DOORS. Digital Orientation is used by new employees, while the Organizational Reference System is used mainly by existing employees. New or prospective employees access the system with an HR supplied time limited code. Existing employees access the system using their corporate accounts.

Digital orientation is taught using video, audio, and text screens. A computer is required for this. Depending on the data transfer medium, a network connection or CDROM player will also be required. These screens are at the priority level. Certain screens provide access to the reference level for those needing greater detail or explanation of information from the priority level. Priority level screen are divided by subject areas (modules), at the end of each, are tests. While taking the tests, New or prospective employees will have access to prior priority and reference levels. In effect this is an open book test allowing access back and forth between the test and its supporting materials. Currently we propose that those going through new orientation achieve 100% on each module test before going on to the next subject.

Subject areas and priority level information and tests are company determined in consultation with corporate legal, HR and other relevant parties. DOORS is customized for each company. There are company defined generic subject areas. Each area is tailored to the specific company's requirements. Additional areas will be added to accommodate trade specific requirements. An example of this is in the chemical industry where MSDS sheets are required for every shipment. There are other chemical industry requirements that every employee in that particular industry should be aware of.

This invention combines and uses current technologies in; Computer Based Training (CBT), Learning Content Management Systems (LCMS), Learning Management Systems (LMS), eLearning, Legal services, Human Resources, Security, IP, etc. For simplicity sake the invention may be referred to as a “course” (courseware) in orientation, and an “organizational reference system” for in-depth or refresher knowledge. The two elements of the invention, instruction and reference, together may be referred to as the “course”, since the material or data is common to both.

### DESCRIPTION OF THE PREFERRED EMBODIMENT

A system in accordance with the present invention includes the following:

Operation of the system requires a storage medium for the course, its data, and testing controls. While the course and data are integral, testing controls provide input relative to the “student” and generate an output, which may be encrypted, representative of the “score” or abilities of the student. The “student” is the company's new hire going through orientation of the organization.

While a computer is needed to take the course, the origin of the material can be generated from a server, or other hard disk medium holding computer programs and data, through a local network, or the internet. Alternatively, the course can originate on a CDROM or other portable computer data storage medium.

To provide security and ensure that only authorized persons view the course, a time limited key is generated that corresponds to the student taking the course. The key's encryption may be dynamic, if generated automatically, or static if other student specific factors are taken into account. While encryption over a network can be dynamically generated, different variables need to be used for static encryption when the source material is on a CDROM. CDROMs may be encrypted using standard industry encryption techniques.

A blended approach in which a live person also provides parallel orientation can be used with this invention. Companies may decide on this approach when non-definable issues such as colors, smells, and other cosmetic relevancies are important to the company. Such an example might be identifying gas leaks for employees of an energy supply company.

The course is created for the client organization, using standard industry courseware generating programs. It should be accessed over IP and viewable through a standard browser. The created courseware includes an instruction set of commands, GUI, and data agreed upon with the company. Data agreed upon with the company may include text, graphics, audio and video, otherwise known as multimedia. Company data is proprietary as determined by the company,

In general the bases for company supplied data is the company's employee manual modified to include presentations in a multimedia format. Data supplied by the company is derived based on company policies, industry and legal requirements, that include input from Human resources, corporate legal council, etc. The intent of company supplied data is to inform company representatives on operating procedures, the corporate environment, legal issues, and any other issues that affect the company, its employees, clients (customers) or the public. The intent of the course is to convey to the prospective company representative, in a manner they can relate to, corporate policies and instructions, then to test them to verify understanding of that data. Since it is acknowledged that retention diminishes dramatically with time, the organizational reference part of the course service to reinforce and provide in-depth understanding and explanation of the company supplied data.

Because standard industry courseware generating programs generate a complete courseware package, the source code for the courseware is the basis on which all changes are made. Courseware generating programs create source code which when converted results in a displayable/playable course. Changes of any kind must be made to the source code for the course to operate correctly. Clients who buy the course must also buy the source code and courseware generating programs to do any work on the courseware in-house.

### BENEFITS OF THIS INVENTION

It lowers corporate exposure to liability claims

Use of today's existing technologies is proven

It lowers HR costs

It lowers employee turnover

It Increase employee efficiencies

It is easily updateable and consistently verifiable

It test employees resolve for employment

It lowers new employee orientation costs

It provides employees a defined environment within which to work

It provides management controls on important information

It defines security and proprietary issues

It makes information at different levels of importance readily available

### BRIEF DESCRIPTION OF THE DRAWINGS

The drawings are representative of the logical construction of the invention. While no single element of the invention is unique in itself, it is the combination of elements that make this invention unique.

FIG. 1 shows an overview of the invention and how it relates to the hiring process, from the beginning, through the body and to the conclusion.

FIG. 2 is an example of basic generic modules used in the invention. While some organization may require as few as four or five modules, other may require twenty or more. Total modules are dependent on the total amount of information made available to new hires and existing organizational representatives

FIG. 3 is a two tier sample during orientation. The priority level is used to convey basic information and test on same. The reference level is used as an adjunct to the priority level and as a reference store for additional reference materials. Although DOORS is based on two tiers of information, organizations may choose to include sub-tiers to accommodate additional amounts of information. This figure is an example of what a new hire going through orientation would have to navigate.

FIG. 4 is a sample for reference access. Although reference is primarily used by existing organization representatives, those accessing the system can choose to review material at the priority level.

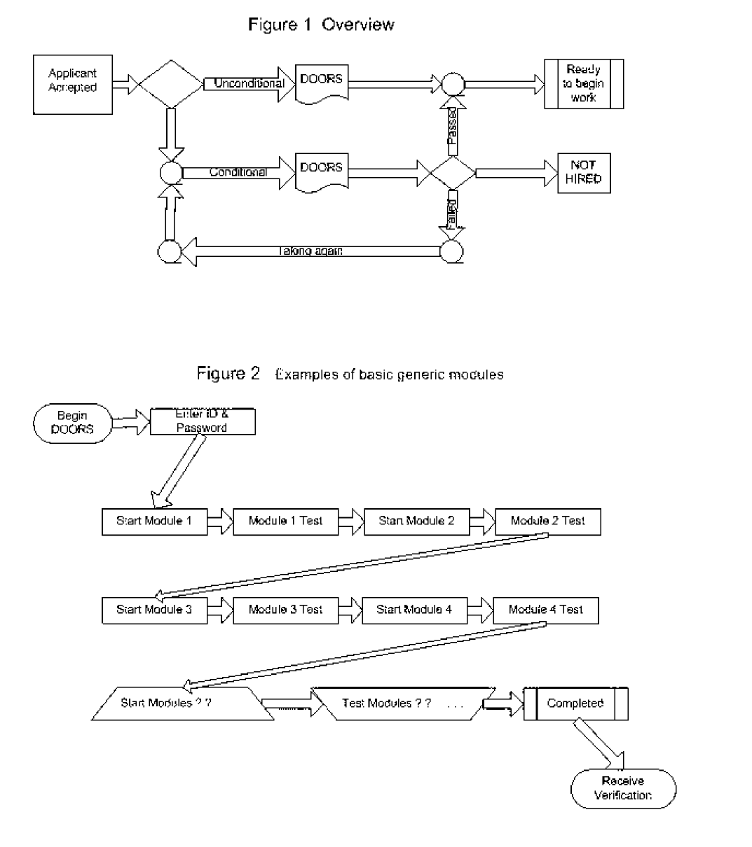

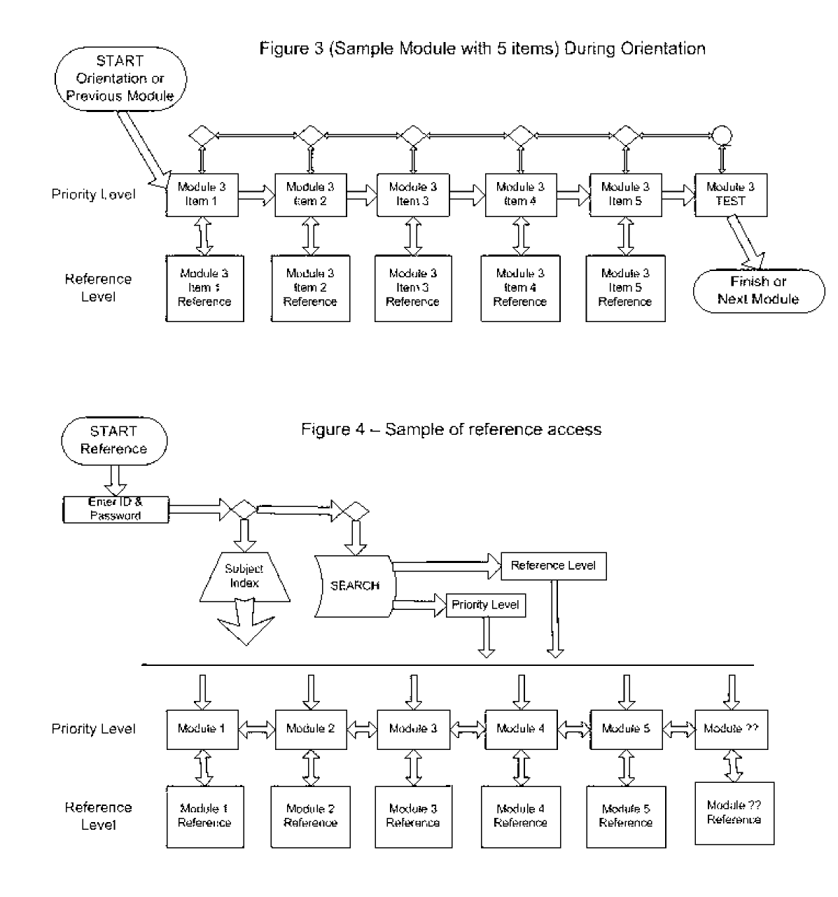

What is claimed is:

1. Whereby a digital process of presenting and verifying general organizational information to new and existing employees or organizational stakeholders for the purpose of lowering organizational liability and increasing organizational representative performance and productivity.

2. Whereby a multi-level (tiered) presentation of multi-media (text, audio and video) information and testing that allows new organizational stakeholders drill-down capabilities for a better understanding of specifics.

3. Whereby a digitized new employee orientation presents and highlights organizational rules, regulations, policies, equipment operation, physical locations and processes, based on common elements frequently found and available to existing employees in employee or company manuals, plus changes.

4. Whereby using computer technology the orientation process can be delivered through any digital medium (online and offline) and ensures repeatable, standardized, and verifiable teaching and testing of material while allowing the same material for reference use by existing employees.

5. A digitized orientation includes input from management, HR, legal, facilities, operations, equipment suppliers and other stakeholders in creating the content. System output is expressed as either a percentage of material tested on or as a pass/fail grade for material learned.

6. Whereby the combination of digitizing the orientation process utilizing the same database of information used in employee manuals will lower organizational liability and result in higher employee performance and productivity. This system is available to existing stakeholders for future reference.
